(19) United States
(12) Patent Application Publication
(10) Pub. No.: US 2026/0237213 A1
(43) Pub. Date: Aug. 13, 2026

(54) OCCUPANT LOCATION MONITORING AND ALERT SYSTEM

(71) Applicant: Erica Ba, Missouri City, TX (US)

(72) Inventor: Erica Ba, Missouri City, TX (US)

(21) Appl. No.: 19/051,823

(22) Filed: Feb. 12, 2025

(51) Int. Cl. G06V 20/52; G06V 10/74; G06V 40/10; G06V 40/70; G08B 3/10; G08B 21/02

(52) U.S. Cl. CPC G06V 20/52; G06V 10/74; G06V 40/10; G06V 40/70; G08B 3/10; G08B 21/02

(57) ABSTRACT

A location monitoring system for monitoring locations and permitted locations of occupants in a facility includes a database which contains occupant data including occupant identity data which represents each occupant of a plurality of occupants of a facility. The occupant data further includes occupant location status data associated with the occupant identity data for designating a location status of each occupant of the plurality of occupants. A user module positioned remotely from the database may access the occupant data by reading a badge having identification data associated with some of the occupant data. The location status data may include permitted destinations such that authorized individuals may monitor whether an occupant is traveling in passageways relevant to such a permitted destination.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to location monitoring systems and more particularly pertains to a new location monitoring system for monitoring locations and permitted locations of occupants in a facility.

### (2) Description of Related Art Including Information Disclosed Under 37 CFR 1.97 and 1.98

The prior art discloses various monitoring systems for monitoring the locations of individuals within a facility such as a school, a hospital, a prison, or the like. However, the prior art fails to describe such a system which allows designation of permitted destinations or permitted tasks such that monitoring individuals may independently assess whether an occupant is travelling in a passageway that may be relevant to the destination or task. The prior art also fails to describe such a system in which a camera on a user module may identify occupants of the facility in order to determine whether an alert message should be relayed to the occupants.

### BRIEF SUMMARY OF THE INVENTION

An embodiment of the disclosure meets the needs presented above by generally comprising a database which contains occupant data including occupant identity data which represents each occupant of a plurality of occupants of a facility. The occupant data further includes occupant location status data associated with the occupant identity data for designating a location status of each occupant of the plurality of occupants. A user module is positioned remotely from the database. The user module comprises a housing which contains a processor that is in communication with the database. The user module further comprises a badge reader, an input, and a display mounted on the housing and operatively coupled to the processor. The badge reader is configured to read identification data stored on an occupant badge, and the processor is configured to access occupant data from the database associated with the identification data. The input is configured to receive commands for accessing occupant data from the database and to write and store occupant location data on the database. The processor is configured to display occupant data via the display module.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a user module of a location monitoring system according to an embodiment of the disclosure.

FIG. 2 is a side view of a user module of an embodiment of the disclosure.

FIG. 3 is a back view of a user module of an embodiment of the disclosure.

FIG. 4 is a block diagram of an embodiment of the disclosure.

FIG. 5 is an in-use view of a user module of an embodiment of the disclosure.

FIG. 6 is a front view of a portable device of an embodiment of the disclosure.

FIG. 7 is a rear view of a portable device of an embodiment of the disclosure.

### DETAILED DESCRIPTION OF THE INVENTION

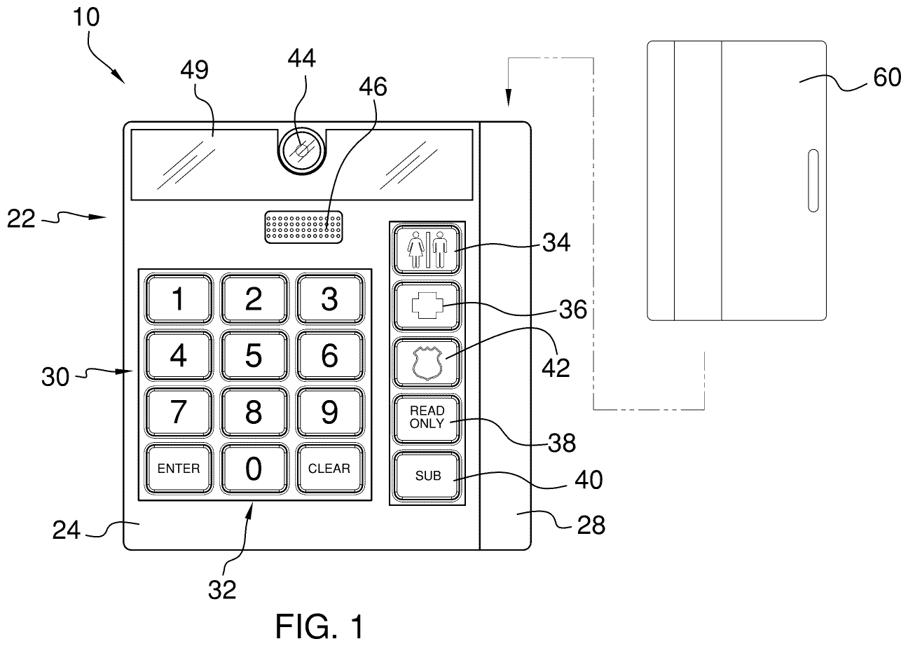

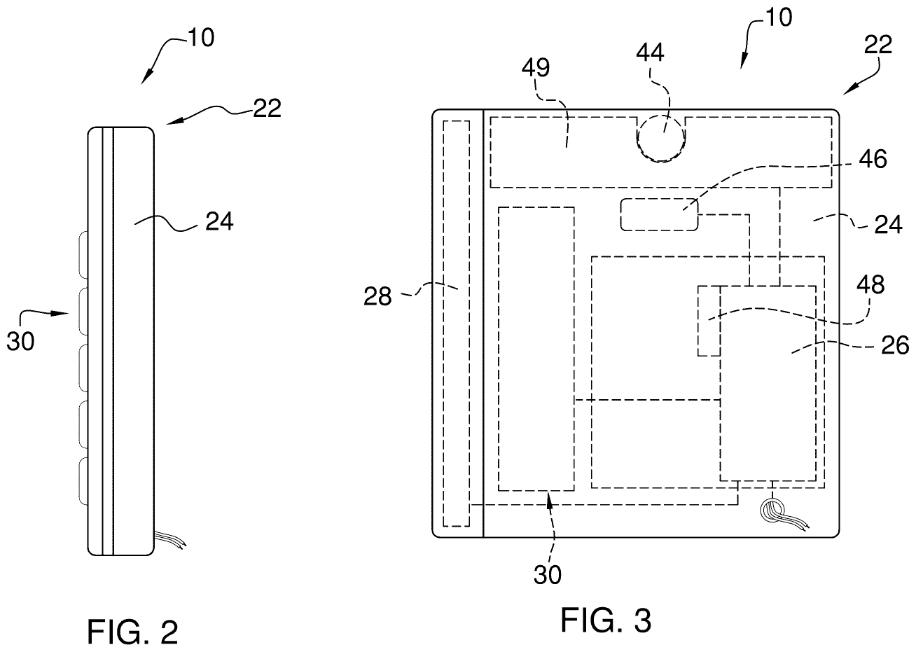

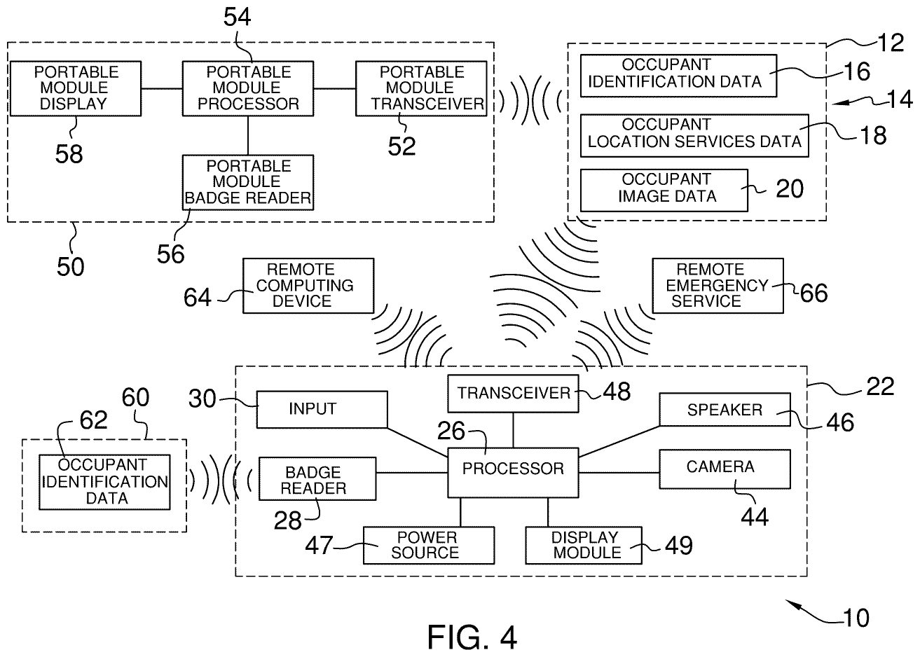

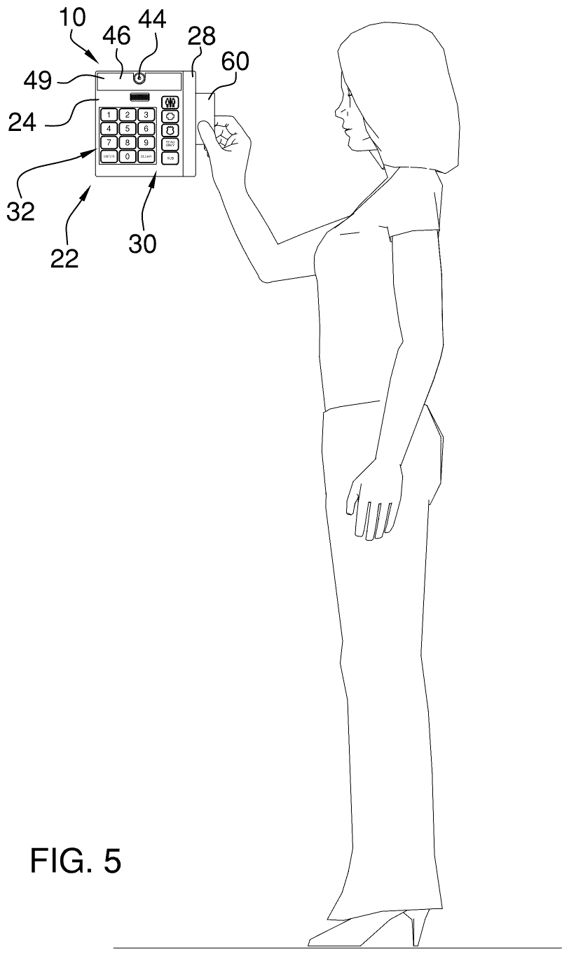

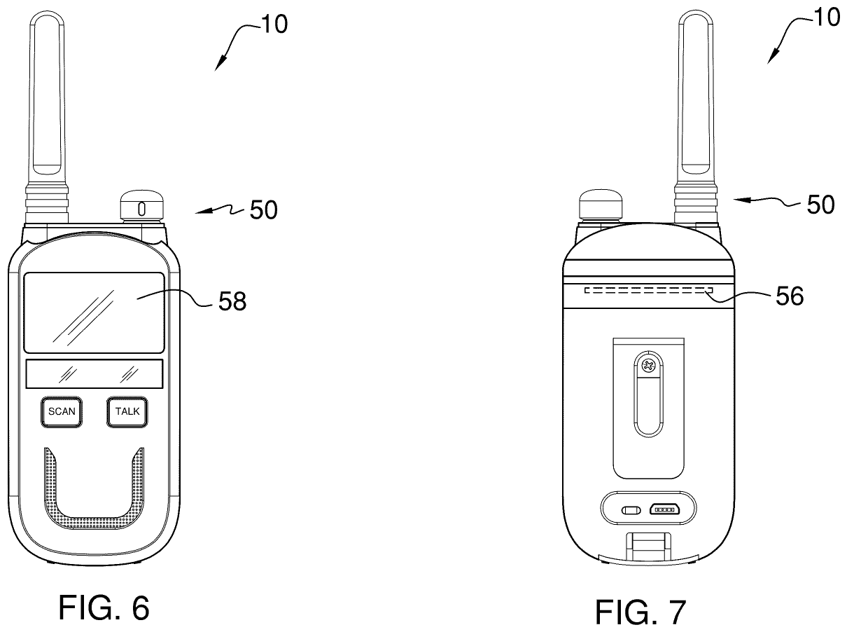

With reference now to the drawings, and in particular to FIGS. 1 through 7 thereof, a new location monitoring system embodying the principles and concepts of an embodiment of the disclosure and generally designated by the reference numeral 10 will be described.

As best illustrated in FIGS. 1 through 7, the location monitoring system 10 generally comprises a database 12 containing occupant data 14 about a plurality of occupants of a facility. For example, the facility may be a school in which the occupants include students, faculty, and administrative staff. The facility may also be a hospital in which the occupants include doctors, patients, and visitors. The location monitoring system 10 may be used in a variety of different facilities in which the occupant data 14 is representative of different types of occupants. For the embodiment described herein, an example use of the location monitoring system 10 in a school will be used throughout.

The occupant data 14 includes occupant identity data 16 which corresponds to each occupant of the plurality of occupants. The occupant identity data 16 may include names, social security numbers, specially assigned identification numbers or codes, or the like. Other identifying information such as birthdates, student grades, departments, professions, and the like may also be included in the occupant identity data 16. The occupant data 14 also includes occupant location status data 18 which is associated with the occupant identity data 16 for designating a location status of each occupant.

The occupant location status data 18 also includes locations within the facility in which the occupant is permitted or expected to be. For example, occupant location status data 18 for each student in a school may include a designation that the student is permitted or assigned to be in certain classrooms throughout the school day. The occupant location status data 18 may also include data which designates that the occupant is assigned or permitted to complete a task which, based on the context of the facility and the task, leads an observer of the occupant data 14 to appreciate that the occupant may be required or permitted to be in certain locations within the facility. For example, occupant location status data 18 for a student may include that the student was given permission at a particular time to use a restroom within a school during a time period in which the students in the school are generally expected to be in a classroom. In this instance, an observer of the occupant location status data 18 would be able to interpret that the student was permitted to traverse one or more hallways to reach and return from the restroom.

The occupant data 14 further includes occupant image data 20 associated with the occupant identity data 16 for visually identifying each occupant of the plurality of occupants. The occupant image data 20 may include, for example, one or more portrait photographs of each occupant, three-dimensional models of the face of each occupant, or the like.

A plurality of user modules 22 may be positioned in different locations throughout the facility. Each user module 22 comprises a housing 24 and a processor 26 mounted in the housing 24. The processor 26 is in communication with the database 12 via a transceiver 48 mounted in the housing 24 and operatively coupled to the processor 26. In other embodiments, the processor 26 may communicate to the database 12 via a wired connection. The processor 26 of each user module 22 is electrically powered by a power source 47 such as a battery, a utility power supply, or another suitable power supply. Each user module 22 includes a badge reader 28 which is mounted to the housing 24 and is operatively coupled to the processor 26. The badge reader 28 as depicted in the Figures comprises a magnetic strip scanning device but may comprise an optical scanner, a radio-frequency identification scanner, or any other suitable scanning device.

The badge reader 28 may be used to scan any of a plurality of occupant badges 60, each of which corresponds to an associated occupant of the plurality of occupants and stores occupant identification data 62 such as a student number, an employee number, or the like. The processor 26 is programmed to access the occupant data 14 corresponding to a given occupant when the occupant identification data 62 stored on an occupant badge 60 associated with the given occupant is read by the badge reader 28. As further described below, the occupant data 14 may also be written via operations performed by a user on the user module 22 which is then stored on the database 12.

Each user module 22 further includes an input 30 which is mounted on the housing 24 and is operatively coupled to the processor 26. The input 30 may be used to key in the occupant identification data 62 rather than using the badge reader 28 to scan one of the occupant badges 60. The input 30 may also be used to receive commands to write and store occupant location data on the database 12. The input 30 includes a numerical keypad 32 which may also include alphabet letters. The numerical keypad 32 may be used, for example, to enter a student identification number in lieu of scanning the occupant badge 60 the student may otherwise have in his or her possession.

The input 30 further includes additional buttons which perform other functions such as adding occupant location status data 18 associated with a given occupant as identified by the occupant identification data 62 being entered by manually keying it in via the input 30 or by scanning the associated occupant badge 60. These additional buttons include a restroom pass button 34 to authorize the given occupant to use the restroom and a nurse pass button 36 to authorize the given occupant to see a school nurse or other medical worker. Such authorizations may be written and stored on the database 12 as occupant location status data 18.

The additional buttons also include a read button 38 for displaying the occupant location status data 18 on a display module 49 of the user module 22, which is mounted on the housing 24 and operatively coupled to the processor 26. The additional buttons further include a submission button 40 for submitting attendance information to the database 12 or another destination such as a remote computing device 64. The submission button 40 may, for example, be used to submit attendance of students in a classroom by receiving the occupant identification data 62 associated with the students via manual entry or scanning occupant badges 60 and the user selecting the submission button 40 thereafter.

The additional buttons also include a security button 42 which causes the processor 26 to send an emergency notification via the transceiver 48 to a remote security device. For example, a notification may be sent to a device in the possession of campus security, a police department, or another remote emergency service 66. The transceiver 48 may communicate over any suitable communications network such as the Internet, radio signals, or the like.

Operation of the input 30 generally controls the processor 26 which includes computer-readable instructions which direct the processor 26 to operate substantially as described above. The input 30 also may comprise other entry means such as a touchscreen, a mouse, a computer keyboard, or the like. Navigable menus may be provided and shown on a monitor such that the different functions of the processor 26 described are selectable via one of the other entry means rather than the additional buttons described.

Each user module 22 also includes a camera 44 and a speaker 46 which are mounted on the housing 24 and operatively coupled to the processor 26. The processor 26 is configured to record images via the camera 44 and compare the recorded images to the occupant image data 20 to identify one or more occupants in the location where the user module 22 is installed. The processor 26 is programmed to selectively cause the speaker 46 to emit an audible alert upon the processor 26 identifying one of the occupants to warn the one occupant of an emergency and direct the occupant to the nearest safe exit. The processor 26 may be programmed to complete this task upon pressing the security button 42 or in response to some other command, such as one received from a separate security system.

Portable devices 50 are also included which are positioned remotely from the database 12 and which communicate wirelessly with the database 12 via portable transceivers 52 included with the portable devices 50. Each portable device 50 includes a portable module processor 54 and a portable module badge reader 56 which is operatively coupled to the portable module processor 54. The portable module badge reader 56 is configured to read the occupant identification data 62 stored on the occupant badges 60 and access the occupant data 14 from the database 12 which is associated with the occupant identification data 62. Each portable device 50 may be operated to display the occupant data 14 on a portable module display 58 which is operatively coupled to the portable module processor 54. The portable devices 50 may comprise radios, smartphones, or other suitable communication devices such that authorized personnel may communicate with each other.

In use, the location monitoring system 10 enables authorized personnel at the facility to monitor the occupant location status data 18 of the various occupants at the facility. For example, teachers and other authorized personnel use the user modules 22 and the portable devices 50 to read the occupant location status data 18 associated with various students by entering the occupant identification data 62 associated with each student and stored on the occupant badge 60 of each student. Occupant location status data 18 may also be altered as described via the user modules 22. In some embodiments, the portable devices 50 also have functions for altering the occupant location status data 18 of the occupant badges 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A location monitoring system for tracking a plurality of occupants of a facility, the location monitoring system comprising:
a database containing occupant data, the occupant data including:
occupant identity data for representing each occupant of the plurality of occupants; and
occupant location status data associated with the occupant identity data for designating a location status of each occupant of the plurality of occupants; and
a user module positioned remotely from the database, the user module comprising:
a housing;
a processor mounted in the housing, the processor being in communication with the database;
a badge reader mounted on the housing and operatively coupled to the processor, the badge reader being configured to read identification data stored on an occupant badge, the processor being configured to access occupant data from the database associated with the identification data;
an input mounted on the housing and operatively coupled to the processor, the input being configured to receive commands for accessing occupant data from the database, the input being configured to write and store occupant location data on the database; and
a display module mounted on the housing and operatively coupled to the processor, the processor being configured to display occupant data via the display module.

2. The location monitoring system of claim 1, wherein the user module comprises a transceiver mounted in the housing and operatively coupled to the processor, the processor being configured to wirelessly communicate with the database via the transceiver.

3. The location monitoring system of claim 2, wherein the processor is configured to wirelessly communicate with a remote emergency service via the transceiver.

4. The location monitoring system of claim 1, wherein the input is configured to receive identification data.

5. The location monitoring system of claim 1, wherein:
the occupant data further includes occupant image data associated with the occupant identity data for visually identifying each occupant of the plurality of occupants; and
the user module further comprises a camera mounted on the housing and operatively coupled to the processor, the processor being configured to record images via the camera, the processor being configured to compare the recorded images to the occupant image data to identify one occupant of the plurality of occupants.

6. The location monitoring system of claim 5, wherein the user module further comprises a speaker mounted to the housing and operatively coupled to the processor, wherein the processor is configured to emit an audible alert via the speaker upon identifying the one occupant.

7. The location monitoring system of claim 1, further comprising a portable device positioned remotely from the database, the portable device being in communication with the database, the portable device comprising:
a portable module processor in wireless communication with the database; and
a portable module badge reader operatively coupled to the portable module processor, the portable module badge reader being configured to read the identification data stored on the occupant badge, the portable module processor being configured to access occupant data from the database associated with the identification data.

8. The location monitoring system of claim 7, wherein the portable device further comprises a portable module display module operatively coupled to the portable module processor, the portable module processor being configured to display occupant data via the display module.

9. A location monitoring system for tracking a plurality of occupants of a facility, the location monitoring system comprising:
a database containing occupant data, the occupant data including:
occupant identity data for representing each occupant of the plurality of occupants;
occupant location status data associated with the occupant identity data for designating a location status of each occupant of the plurality of occupants; and
occupant image data associated with the occupant identity data for visually identifying each occupant of the plurality of occupants;
a user module positioned remotely from the database, the user module being configured to be fixed within the facility, the user module comprising:
a housing;
a processor mounted in the housing, the processor being in communication with the database;
a transceiver mounted in the housing and operatively coupled to the processor, the processor being configured to wirelessly communicate with the database via the transceiver, the processor being configured to wirelessly communicate with a remote emergency service via the transceiver;
a badge reader mounted on the housing and operatively coupled to the processor, the badge reader being configured to read identification data stored on an occupant badge, the processor being configured to access occupant data from the database associated with the identification data;
an input mounted on the housing and operatively coupled to the processor, the input being configured to receive identification data, the input being configured to receive commands for accessing occupant data from the database, the input being configured to write and store occupant location data on the database;
a display module mounted on the housing and operatively coupled to the processor, the processor being configured to display occupant data via the display module;
a camera mounted on the housing and operatively coupled to the processor, the processor being configured to record images via the camera, the processor being configured to compare the recorded images to the occupant image data to identify one occupant of the plurality of occupants; and
a speaker mounted to the housing and operatively coupled to the processor, wherein the processor is configured to emit an audible alert via the speaker upon identifying the one occupant; and
a portable device positioned remotely from the database, the portable device being in communication with the database, the portable device comprising:
a portable module processor in wireless communication with the database;
a portable module badge reader operatively coupled to the portable module processor, the portable module badge reader being configured to read the identification data stored on the occupant badge, the portable module processor being configured to access occupant data from the database associated with the identification data; and
a portable module display module operatively coupled to the portable module processor, the portable module processor being configured to display occupant data via the display module.
